(19) United States
(12) Patent Application Publication
(10) Pub. No.: US 2005/0128749 A1
(43) Pub. Date: Jun. 16, 2005

(54) Hand-held stabilized laser pointer

(76) Inventors: Jeffrey Dale Wilson, Goleta, CA (US); Daniel Steven Sanchez, Santa Barbara, CA (US)

Correspondence Address: Patent Law Office, P.O. Box 91929, Santa Barbara, CA, 93190-1929, US

(21) Appl. No.: 10/735,020

(22) Filed: Dec. 12, 2003

(51) Int. Cl. F21K 2/00; F21L 2/00

(52) U.S. Cl. 362/259; 362/157

(57) ABSTRACT

A hand-held laser pointer is disclosed that comprises a laser module that is isolated from unwanted hand tremor motions of the laser pointer housing. A passive inertial stabilizer is utilized for stabilizing the laser module to suppress laser dot jitter associated with hand tremor. To achieve the above object, a collimated laser diode module is mounted on a stage that is suspended by a low-friction gimbal that pivots with respect to the housing of the pointer on two intersecting and mutually perpendicular axes. The inertial stage is coupled to the housing via a spring and damper.

### BACKGROUND OF THE INVENTION

1. Field of the Invention

The present invention relates to laser pointers. More particularly, the present invention relates to hand-held laser pointers. Even more particularly, the present invention relates to a hand-held laser pointer stabilized against hand tremor.

2. Prior Art

Various hand-held laser pointers have been taught for visually pointing out a target on, for example, a whiteboard, chart, map, or projected display. Laser pointers typically include a laser diode module that produces a collimated laser beam. The laser diode module is packaged within a housing and is battery powered. A user holds the pointer in one hand and directs the laser beam towards a target, generally during a presentation or the like.

The effectiveness of such hand-held laser pointers for particularly pointing out a target is reduced by the unintentional tremor of the user's hand. Human tremor is an involuntary trembling or shaking of the muscles of the body associated with physical weakness, emotional stress, or excitement. The small angular movements of the hand from tremor impart undesirable motion to the laser pointer and its corresponding laser beam and image, which is generally a small dot indicating where the beam is striking the target. This unwanted motion is amplified as the distance between the laser diode and the target increases and generally results in visibly shaky movements of the laser dot. The jitter of the laser dot limits the user's pointing resolution which may distract an audience, expose nervousness and may act to discredit the user.

To address this problem, some hand-held laser pointer devices have been taught that blink on and off, or create a pulsed laser beam. These devices mask the problem and do not stabilize the orientation of the laser light beam. Uninterrupted siting of the laser dot is additionally not achieved by this type of laser pointer.

Other suggested means for coping with hand tremor while pointing a hand-held laser pointer include turning the laser on only momentarily, holding the pointer with both hands to reduce tremor, resting the pointing hand, wrist, or arm on a stable object, or connecting the pointing device directly to a stable object such as a podium. The lack of an adequate solution to this problem has prompted many to suggest that hand-held laser pointers should not be used during presentations. There is a need in the art for an improved hand-held laser pointer that substantially eliminates the effect of hand tremor on the direction of the laser beam produced by a hand-held laser pointer.

### SUMMARY

It is a primary object of the present invention to provide a hand-held laser pointer that suppresses or minimizes laser dot jitter associated with hand tremor.

To meet the above object of the invention, a hand-held laser pointer is disclosed that generally comprises:
(a) a housing having an interior chamber and a longitudinal axis;
(b) a power source disposed within the interior chamber of the housing; and
(c) a laser module disposed within the interior chamber of the housing, the laser module being in electrical communication with the power source and operable for producing a laser beam,
   wherein the laser module is passively inertially stabilized with respect to motion of the housing about at least one axis perpendicular to the longitudinal axis of the housing.

In a preferred embodiment of a hand-held laser pointer operable for providing a laser beam having a direction defining a longitudinal axis, the laser pointer comprises: (a) a housing; (b) a laser module enclosed within the housing; (c) a power supply enclosed within the housing and in electrical communication with the laser module; (d) a counterweight rigidly attached to the laser module by a bridge, the laser module, counterweight and bridge collectively forming an inertial mass having a center of gravity disposed on the bridge; (e) a gimbal affixed to said housing and said bridge at the center of gravity of said inertial mass, said gimbal pivoting on two intersecting and mutually perpendicular axes; and (f) means for biasing said gimbal-mounted inertial mass to a neutral position with respect to said housing, said biasing means being operable for damping angular vibration between said inertial mass and said housing while enabling said laser pointer to be panned. The counterweight is preferably adjustable towards and away from said mutually perpendicular pivot axes of said gimbal. The means for biasing the inertial mass to a neutral position preferably employs a magnetic field interaction between a magnetic or ferromagnetic first material disposed on the inertial mass, and a ferromagnetic or magnetic second material affixed to said housing. An electrically conductive material may be disposed between said first material and said second material to dampen the magnetic interaction therebetween by the generation of eddy currents therein. Preferably, the ferromagnetic or magnetic second material is movably mounted to the housing and adjustable towards and away from the magnetic or ferromagnetic first material.

The laser assembly is mounted to a pitch and yaw inertially stabilized frame disposed within the housing that provides for pivoting of the laser assembly with respect to the housing about two axes that are orthogonal to the longitudinal axis and to each other. The inertial stabilization is accomplished passively. The laser assembly serves as an inertial mass that is balanced to be substantially free from gravitational influence while gimballed to the housing. The inertial mass is spring biased to a neutral position with respect to the housing. A damping element may be positioned interior the housing and is provided to improve stabilization.

Low frequency angular movements of the housing are transmitted to the laser assembly while angular movements of the housing substantially at or above a predetermined frequency and, preferably, in a range similar to the frequencies associated with hand tremor, are isolated from the laser assembly.

The features of the invention believed to be novel are set forth with particularity in the appended claims. However the invention itself, both as to organization and method of operation, together with further objects and advantages thereof may be best understood by reference to the following description taken in conjunction with the accompanying drawings.

### BRIEF DESCRIPTION OF THE DRAWINGS

FIG. 1 is a partially cutaway perspective view of a tremor-stabilized, hand-held laser pointer in accordance with the present invention.

FIG. 2 is a side plan view of the laser pointer of FIG. 1.

FIG. 3 is a schematic view of a gimbal included in a laser pointer according to the present invention.

### DESCRIPTION OF THE PREFERRED EMBODIMENTS

Definitions

The term “passive” or “passive stabilization”, as used herein to describe means for stabilizing a laser module, means a stabilization mechanism operable for damping low frequency vibrations of the laser module that does not require a source of power for its operability.

The term “low frequency” as used herein means vibrations in the range of 2-10 Hertz.

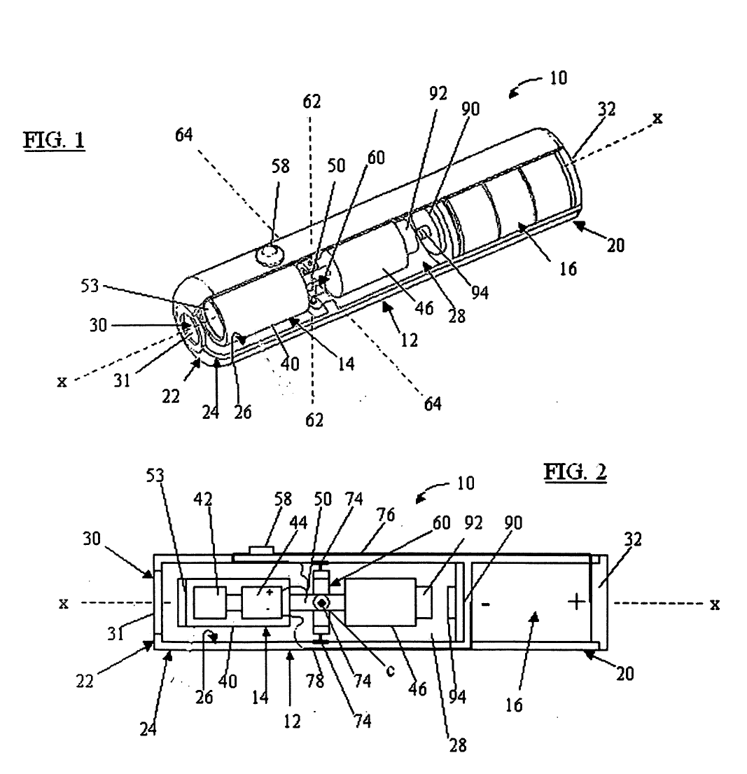

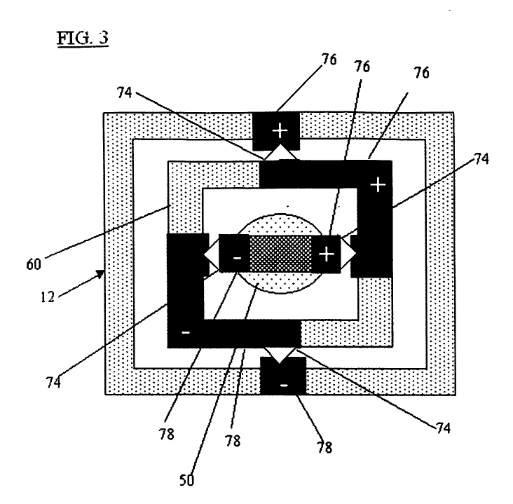

Referring to FIGS. 1 and 2, the preferred embodiment of a hand-held laser pointer in accordance with the present invention is shown at 10. The laser pointer 10 generally includes a housing 12, a laser assembly 14, and a power source 16. The housing 12 has a proximal end 20, a distal end 22, an outer surface 24 and an inner surface 26. The housing 12 defines an open interior 28. The housing has an aperture 30 formed therethrough, preferably at its distal end 22.

A transparent material 31 is seated within the aperture 30 such as clear plastic, glass, or some well known optically transparent material, to separate the interior of the housing 12 from the external environment. The aperture 30 defines an optical aperture. The housing 12 includes a power supply access 32 for facilitating the mounting and dismounting of the power source 16. The power source 16 is preferably a single battery or a plurality of batteries. Button-shaped batteries may be employed that meet the size and electrical requirements of the laser assembly 14.

The laser assembly 14 includes a collimating lens 53, a laser element 42, and a driving circuit 44 disposed within a module housing 40. The laser element 42 is preferably a laser diode that emits coherent light of a desired color such as red, green, or blue laser light. The emitted light is collimated into a light beam via the collimating lens 53. The driving circuit 44 is electronically connected to the laser element 42 and serves to regulate power from the power source 16 and cause the laser to emit light. Such components may include lenses, mounts, wiring, and other components well known to those skilled in the art to which the present invention relates. Suitable laser elements 42 are produced by Nichia Corporation having a principle place of business at 491 Oka, Kaminaka-Cho, Anan-Shi, Tokushima 774-8601, Japan and by Cree, Inc., having a place of business at 4600 Silicon Drive, Durham, N.C. 27703.

The laser assembly housing 40 is mounted to counterweight 46 via a bridging element 50. The weighted element 46 defines or comprises a counterweight to the laser assembly 14 and laser assembly housing 40 so that the counterweight 46 and the laser module housing 40, including elements contained therein, are balanced about a centerpoint C of the bridging element 50. The bridging element 50 is suspended in the housing 12 by a low friction gimbal 60 that pivots about substantially perpendicular first and second axes 62, 64 each of which is perpendicular to longitudinal axis x. The gimbal 60 is pivotally mounted to the housing 12 at the inner surface 26 thereof and to the bridging element 50. Such pivotal mounting may be accomplished via pairs of pin and cup mechanisms 74 or other low friction bearing elements.

The laser module housing 40 and the counterweight 46, and the bridging element 50 therebetween act as a pivoting inertial mass suspended within the gimbal 60. The laser module housing 40, the counterweight 46, and the bridging element 50 therebetween may be formed from synthetic resinous materials or metallic materials.

In a preferred embodiment of the stabilized laser pointer 10, a magnet 92 is rigidly mounted to the proximal end of the counterweight 46. A body comprised of a ferromagnetic material 90 is disposed within the housing interior 28 intermediate the power source 16 and the magnet 92. The magnet 92 interacts with the ferromagnetic material 90 to provide a magnetic spring coupling between the pivoting inertial mass and the housing 12.

A conductive non-magnetic material 94 is preferably disposed intermediate the magnet 92 and the ferromagnetic material 90 and serves to dampen the magnetic spring coupling between the pivoting inertial mass and the housing 12. The materials and relative sizes of the magnet 92, the ferromagnetic material 90, and the conductive non-magnetic material 94 are selected so that angular motions of the housing 12 at low frequency, generally below 4 Hz, will be transmitted to the pivoting inertial mass comprising the laser assembly 14, while higher frequency angular motions of the housing 12 will be isolated from the inertial mass comprising the laser assembly 14.

Essential tremor and postural tremor frequencies are generally between Hz and 12 Hz. As such, the spring (magnetic coupling) and damping characteristics are sized for effective isolation of angular motion imparted to the laser assembly 14 about axes 62, 64 within this frequency range, while providing adequate angular motion coupling about axes 62, 64 for effective panning and tilting of the laser assembly 14 during use. Various arrangements of these or other spring and damping materials may be employed to provide alternate or adjustable spring and damping characteristics.

With reference now to FIGS. 2 and 3, the laser assembly 14 is electronically connected to the power source 16 via two electrical paths 76 and 78. At least one of these paths is electronically connected to a switch 58 on the housing 12. Power is supplied to the laser assembly 14 by actuating the switch 58. Electrical connections between the power source 16, the switch 58, and the laser assembly 14 may be comprised of flexible wiring. Alternatively, electrical paths between the switch 58, the laser assembly 14, and the power source 16 can be routed via isolated conductive pathways through the bearing elements of the gimbal 60 as shown in FIG. 3. This embodiment decouples wiring forces that may serve to degrade the performance of the inertially stabilized frame.

When the user grasps the laser pointer 10 with his/her hand and switches on the switch 58, the laser beam is emitted from the laser assembly 14 through the aperture 30 formed at the distal end 22 of the housing 12 towards a target. Low frequency angular movements of the housing will be transmitted to the laser assembly 14 and its emitted laser beam while angular movements of the housing 12 substantially at or above a predetermined frequency and, preferably, in a range similar to the frequencies associated with hand tremor, will be isolated from the laser assembly 14 and its emitted laser beam. The preferred embodiment of the present invention passively accomplishes stabilization of hand tremor that may be imparted to the laser pointer 10. A power source is not required for stabilization and it is more cost effective to stabilize the laser assembly 14 in a passive fashion in accordance with the present invention.

While particular embodiments of the present invention have been illustrated and described, it would be obvious to those skilled in the art that various other changes and modifications can be made without departing from the spirit and scope of the invention. For example, the laser pointer may further include an elastically deformable material disposed within the interior 28 between the counterweight 46 and the inner surface 26 of the housing 12. In addition, the laser pointer may be mounted on a transportable device, as, for example, on a vehicle, and still enjoy the advantages of the stabilization system. It is therefore intended to cover in the appended claims all such changes and modifications that are within the scope of this invention.

1. A hand-held laser pointer comprising:
(a) a housing having an interior chamber and a longitudinal axis;
(b) a power source disposed within the interior chamber of said housing; and
(c) a laser module disposed within said interior chamber of said housing, said laser module in electrical communication with said power source, said laser module being operable for producing a laser beam, said laser beam being dampened with respect to angular vibration of the housing about at least one axis perpendicular to said longitudinal axis of said housing.

2. A hand-held laser pointer comprising:
(a) a housing having an interior chamber and a longitudinal axis;
(b) a power source disposed within the interior chamber of said housing; and
(c) a laser module disposed within said interior chamber of said housing, said laser module in electrical communication with said power source, said laser module being operable for producing a laser beam, said laser beam being passively dampened with respect to angular vibration of the housing about at least one axis perpendicular to said longitudinal axis of said housing.

3. A hand-held laser pointer operable for providing a laser beam in a direction defining a longitudinal axis, said laser pointer comprising: (a) a housing; (b) a laser module enclosed within said housing; (c) a power supply enclosed within said housing and in electrical communication with said laser module; (d) a counterweight rigidly attached to said laser module by a bridge, said laser module, counterweight and bridge collectively forming an inertial mass having a center of gravity disposed on said bridge; (e) a gimbal affixed to said housing and said bridge at the center of gravity of said inertial mass, said gimbal pivoting on two intersecting and mutually perpendicular axes; and (f) means for biasing said gimbal-mounted inertial mass to a neutral position with respect to said housing, said biasing means being operable for damping angular vibration between said inertial mass and said housing while enabling said laser pointer to be panned.

4. The laser pointer of claim 3 wherein said counterweight is adjustable towards and away from said mutually perpendicular pivot axes of said gimbal.

5. The laser pointer of claim 3 wherein said means for biasing said inertial mass to a neutral position employs a magnetic field interaction between a magnetic or ferromagnetic first material disposed on the inertial mass and a ferromagnetic or magnetic second material affixed to said housing.

6. The laser pointer of claim 5 further comprising an electrically conductive material disposed between said first material and said second material.

7. The laser pointer of claim 5 wherein said ferromagnetic or magnetic second material is movably mounted to said housing and adjustable towards and away from said magnetic or ferromagnetic first material.

8. The laser pointer of claim 5 comprising range limiting means operable for limiting the range of angular motion of said inertial mass.
